(19) United States
(12) Patent Application Publication
(10) Pub. No.: US 2014/0153020 A1
(43) Pub. Date: Jun. 5, 2014

(54) IMAGE PROCESSING APPARATUS, CONTROL METHOD FOR IMAGE PROCESSING APPARATUS, PROGRAM, AND IMAGE FORMING APPARATUS

(71) Applicant: CANON KABUSHIKI KAISHA, Tokyo (JP)

(72) Inventor: Tomohiro Tachikawa, Tokyo (JP)

(73) Assignee: CANON KABUSHIKI KAISHA, Tokyo (JP)

(21) Appl. No.: 14/092,445

(22) Filed: Nov. 27, 2013

(30) Foreign Application Priority Data
Dec. 3, 2012 (JP) 2012-264255

(51) Int. Cl. H04N 1/00; G06K 15/00

(52) U.S. Cl. CPC H04N 1/00896; G06K 15/4055; H04N 1/00904
USPC 358/1.13

(57) ABSTRACT

An image processing apparatus includes a detection unit configured to detect a presence of an object for a single area or multiple areas individually and obtain a location of each of the areas where the object is detected as detection location information, a registration unit configured to register a piece or multiple pieces of detection pattern information that can identify a piece or multiple pieces of detection location information and a detection order thereof, and a control unit configured to perform control such that a return process for switching a power state from a second power state to a first second power state is started when the detection location information sequentially detected by the detection unit is matched with a detection-order leading part of any of the detection pattern information registered in the registration unit, and the return process is continued while the detection pattern information is matched.

### BACKGROUND OF THE INVENTION

1. Field of the Invention

The present invention relates to control in which an image processing apparatus detects proximity of a user by using a sensor configured to detect the presence of an object and returns from a power saving state to a normal state.

2. Description of the Related Art

In some of image processing apparatuses in related art, a power state is shifted to a power saving state in a case where an operation has not been conducted for a certain period of time. However, it takes time when the image processing apparatuses return from the power saving state to a normal state, and usability for a user may be degraded in some cases.

To solve this problem, Japanese Patent Laid-Open No. 2012-177796 proposes a technology with which the image processing apparatus returns from the power saving state to the normal state while proximity of humans is detected by a sensor.

However, the apparatus disclosed in Japanese Patent Laid-Open No. 2012-177796 may accidentally detect a person who does not use the image processing apparatus such as a passer-by and return from the power saving state to the normal state, which causes a problem of unwanted power consumption.

It is also conceivable to solve this problem through a method of avoiding the accidental detection by decreasing a detection sensitivity of the sensor so as to narrow a detection area. However, in that case, a distance at which proximity of an actual operator is certainly detected is shortened, and the image processing apparatus may be halfway through returning to the normal state even when the operator arrives at the image processing apparatus. Thus, the usability for the operator is degraded. As described above, it is difficult to realize at high levels both the suppression of the power consumption caused by the unwanted returning to the normal state through the accidental detection of a person as the operator and the prompt returning from the sleep state.

### SUMMARY OF THE INVENTION

The present invention has been made to solve the above-described problem. The present invention is aimed at providing a mechanism in which it is possible to realize at high levels both the suppression of the wasteful power consumption caused by the unwanted returning to the normal state through the accidental detection of a person as the operator and the prompt returning from the sleep state.

According to an aspect of the present invention, there is provided an image processing apparatus in which a power state is switchable between a first power state and a second power state where a power consumption is lower than in the first power state, the image processing apparatus including:

a detection unit configured to detect a presence of an object for a single area or multiple areas individually and obtain a location of each of the areas where the object is detected as detection location information;

a registration unit configured to register a piece or multiple pieces of detection pattern information that can identify a piece or multiple pieces of detection location information and a detection order thereof; and

a control unit configured to perform control such that a return process for switching the power state from the second power state to the first power state is started when the detection location information sequentially detected by the detection unit is matched with a detection-order leading part of any of the detection pattern information registered in the registration unit, the return process is continued while the detection pattern information is matched, and the return process is not continued when the detection pattern information is not matched.

Further features of the present invention will become apparent from the following description of exemplary embodiments with reference to the attached drawings.

### BRIEF DESCRIPTION OF THE DRAWINGS

FIG. 1 is a block diagram of an exemplary configuration of an image processing apparatus according to an embodiment of the present invention.

FIG. 2 illustrates a positional relationship between the image processing apparatus and a detection area of a sensor unit in a case where the image processing apparatus is viewed from the side.

FIG. 3 illustrates a positional relationship between the image processing apparatus and the detection area of the sensor unit in a case where the image processing apparatus is viewed from the top.

FIGS. 4A to 4E are explanatory diagrams for describing area groups subjected to grouping by some areas of the multiple sensor detection areas according to the present embodiment.

FIG. 5 illustrates the respective area groups illustrated in FIGS. 4A to 4E which are displayed by way of different grid patterns.

FIG. 6 illustrates an example of an area Grp correspondence table representing correspondences between the respective areas illustrated in FIGS. 4A to 4E and FIG. 5 and the respective area groups.

FIG. 7 illustrates an example of activation start determination information according to the present embodiment.

FIG. 8 illustrates an example of detection pattern information according to the present embodiment.

FIG. 9 illustrates an example of return list information according to the present embodiment.

FIGS. 10A and 10B illustrate an example of a display screen of an operation panel unit.

FIG. 11 is a flowchart of an example of a pattern detection process according to the present embodiment.

FIG. 12 is a flowchart of an example of a pattern comparison/addition process according to the present embodiment.

FIG. 13 is a flowchart of an example of a pattern deletion process according to the present embodiment.

FIG. 14 is a flowchart of an example of the operation panel pattern deletion process according to the present embodiment.

FIGS. 15A and 15B illustrate an example of exterior appearances of the image processing apparatus.

### DESCRIPTION OF THE EMBODIMENTS

Hereinafter, embodiments for carrying out the present invention will be described by using the drawings.

### First Embodiment

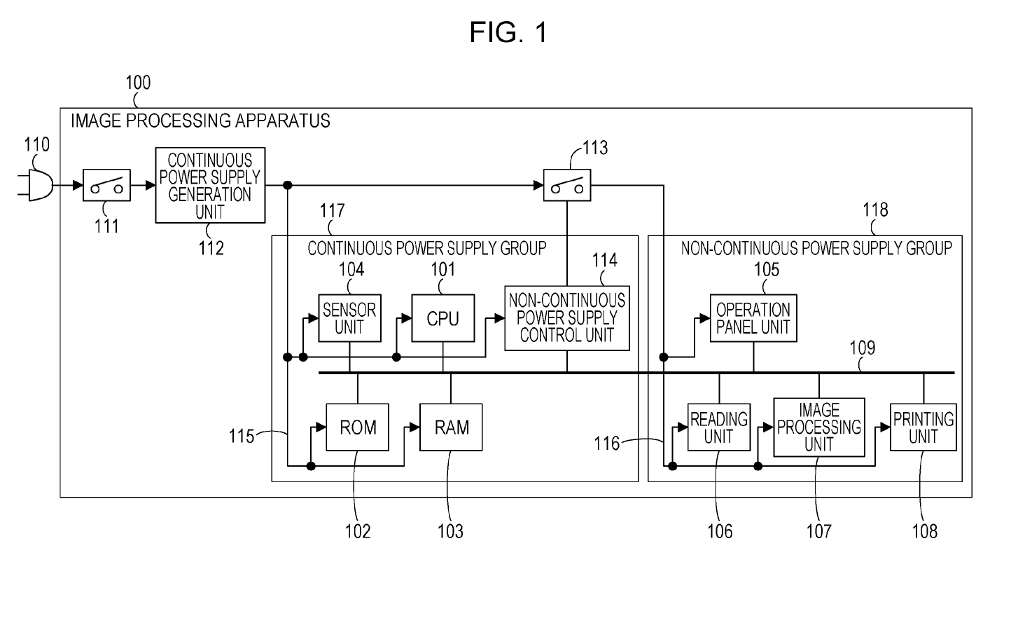

FIG. 1 is a block diagram of an exemplary configuration of an image processing apparatus according to an embodiment of the present invention. FIG. 1 illustrates an image processing apparatus 100 (multifunction peripheral (MFP)) according to the present embodiment. A CPU 101 is a processor configured to perform power supply control according to the present embodiment. A ROM 102 stores a program and data of the CPU 101. The ROM 102 is a flash ROM, and the data therein can be rewritten by the CPU 101. A RAM 103 is used when the CPU 101 executes the program.

A sensor unit 104 is composed of a human presence sensor represented by a pyroelectric array sensor and can detect the presence of an object. The sensor unit 104 can divide a sensor detection range into multiple areas and detect presence of the object for each of the areas. The object detected by the sensor unit 104 may be a still object or a moving object. According to the present embodiment, the description will be given while the object detected by the sensor unit 104 is humans, but the object detected by the sensor unit 104 is not limited to a person. According to the present embodiment, the sensor unit 104 can detect the presence of a person, for example, on the basis of the infrared radiation amount or the like, and can divide the sensor detection range into the multiple areas and detect the presence of the person for each of the areas. The CPU 101 can obtain a location of the area detected by the sensor unit 104 from the sensor unit 104 as area location information. The pyroelectric array sensor is a sensor obtained by arranging pyroelectric sensors in an array of N×N (according to the present embodiment, the array of arranging the pyroelectric sensors by 7×7 is used for the description, but the configuration is not limited to this). In addition, the pyroelectric sensor is a passive-type human presence sensor and is configured to detect proximity of a human body by detecting a temperature change based on infrared radiation naturally radiated from an object having a temperature such as a human body. Features of the pyroelectric sensor include a low power consumption and a relatively wide detection area. A sensor array constituting the sensor unit 104 is not limited to the pyroelectric sensor array, and a human presence sensor array of other types may be employed.

An operation panel unit 105 is configured to accept an operation to be conducted in the image processing apparatus 100 and display a state of the image processing apparatus 100 and so on.

A reading unit 106 is configured to read an original and generate image data. An image processing unit 107 is configured to receive the image data generated by the reading unit 106 via the RAM 103 and perform image processing on the image data. A printing unit 108 receives the image data on which the image processing has been performed by the image processing unit 107 via the RAM 103 and prints the image data on a paper medium or the like.

A power supply plug 110 is used to supply a power supply voltage. A main switch 111 is used by a user to physically turn on and off a power supply of the image processing apparatus 100. A continuous power supply generation unit 112 is configured to generate a power supply to be supplied to the CPU 101 or the like from the power supply voltage supplied from the power supply plug 110.

A power supply line 115 is used to regularly supply the power generated by the continuous power supply generation unit 112 during the main switch 111 being turned on. A continuous power supply group 117 receives power through the power supply line 115.

A power supply control element (FET) 113 can electronically turn on and off the power supply. A non-continuous power supply control unit 114 is configured to generate signals for turning on and off the power supply control element 113.

An output power supply line 116 of the power supply control element 113 is connected to the operation panel unit 105, the reading unit 106, the image processing unit 107, and the printing unit 108. A non-continuous power supply group 118 receives power through the output power supply line 116 of the power supply control element 113.

A bus 109 connects the CPU 101, the ROM 102, the RAM 103, the sensor unit 104, the operation panel unit 105, the reading unit 106, the image processing unit 107, the printing unit 108, and the non-continuous power supply control unit 114 to each other.

According to the present embodiment, the CPU 101 operates the power supply control element 113 via the non-continuous power supply control unit 114 to stop the power supply to the output power supply line (non-continuous power supply line) 116 and interrupt the power supply to the non-continuous power supply group 118, thereby reducing the power consumption of the image processing apparatus 100. Hereinafter, a state of the image processing apparatus 100 in which the power is supplied only to the continuous power supply group 117 is described as “a power saving state”, and the operation on the state by the CPU 101 is described as the operation to “shift to the power saving state”. In the power saving state, an image processing operation is not conducted. That is, the power saving state refers to a state in which an image is not formed.

The CPU 101 also applies the power to the output power supply line 116 of the power supply control element 113 via the non-continuous power supply control unit 114 to establish a state in which the operation panel unit 105 and the like included in the non-continuous power supply group 118 can be operated. Hereinafter, a state of the image processing apparatus 100 in which the power supply to both the continuous power supply group and the non-continuous power supply group is turned on is described as “a normal state”, and the operation on the state by the CPU 101 is described as the operation to “shift to the normal state” or “return to the normal state”. In the normal state, the image processing operation can be conducted. That is, the normal state refers to a state in which an image can be formed.

In the power saving state, also in the continuous power supply group 117 where the power is applied, the RAM 103 may be in a self-refresh state, and the CPU 101 may also be shifted to a power saving mode.

As described above, the image processing apparatus 100 can be operated at least in the normal state (first power state) and the power saving state (second power state) where the power consumption is lower than in the normal state.

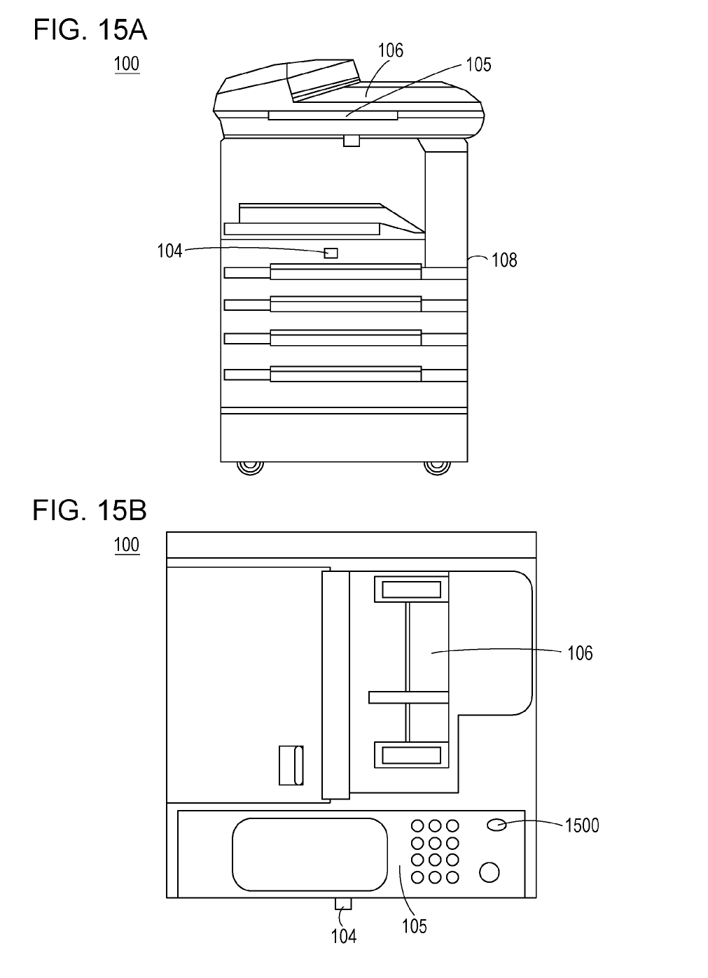

FIGS. 15A and 15B illustrate an example of exterior appearances of the image processing apparatus 100, and components identical to those illustrated in FIG. 1 are assigned with the identical reference numerals.

FIG. 15A corresponds to a front view of the image processing apparatus 100, and FIG. 15B corresponds to a top view of the image processing apparatus 100.

A return switch 1500 is used for instructing the image processing apparatus 100 of the returning from the power saving state to the normal state by the user operation.

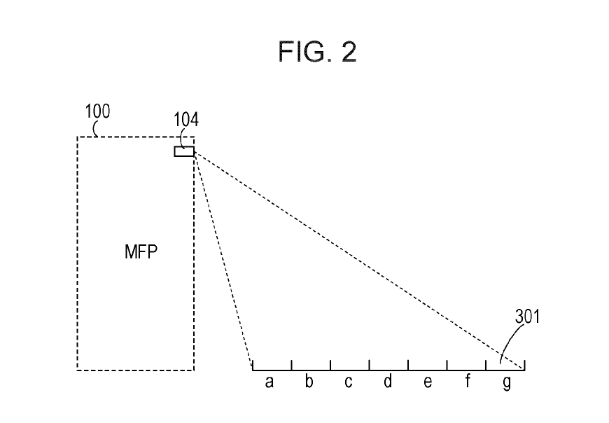

FIG. 2 illustrates a positional relationship between the image processing apparatus 100 and a detection area of the sensor unit 104 in a case where the image processing apparatus 100 is viewed from the side. Components identical to those illustrated in FIG. 1 are assigned with the identical reference numerals.

In FIG. 2, a detection area 301 corresponds to an area where the sensor unit 104 facing forward and downward with respect to the image processing apparatus 100 can perform the detection.

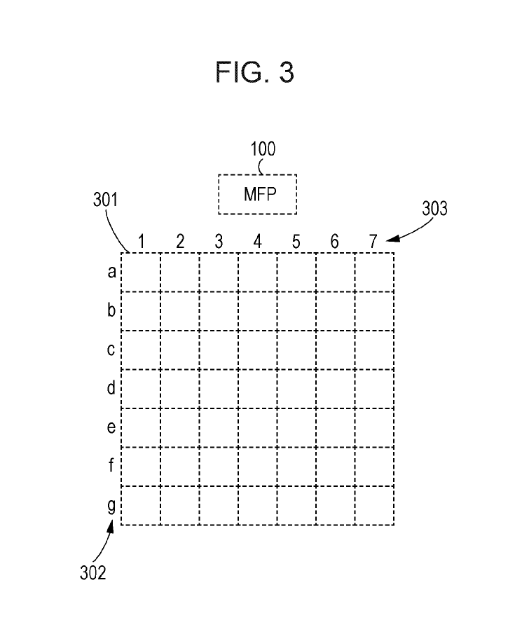

FIG. 3 illustrates a positional relationship between the image processing apparatus 100 and the detection area 301 of the sensor unit 104 in a case where the image processing apparatus 100 is viewed from the top. Components identical to those illustrated in FIG. 2 are assigned with the identical reference numerals.

According to the present embodiment, the pyroelectric array sensor obtained by arranging the pyroelectric sensors in a 7×7 array shape is used for the sensor unit 104. Multiple areas that can individually be detected by the sensor unit 104 are represented by a 7×7 grid as illustrated with reference numeral 301 in FIG. 3. The respective detection areas correspond to the respective pyroelectric sensors in the pyroelectric array sensor on one-to-one basis, and it is possible to determine in which area the person is detected on the basis of the detection states of the respective pyroelectric sensors.

Names 302 for rows of the grid are used for describing locations of the respective detection areas and are a, b, c, d, e, f, and g from the row closer to the image processing apparatus 100.

Names 303 for columns of the grid are 1, 2, 3, 4, 5, 6, and 7 from the left with respect to the image processing apparatus 100.

In the description according to the present embodiment, locations of the areas are described in such a manner that with respect to the image processing apparatus 100, the leftmost area closest to the image processing apparatus 100 is denoted by a1, and the rightmost area closest to the image processing apparatus 100 is denoted by a7.

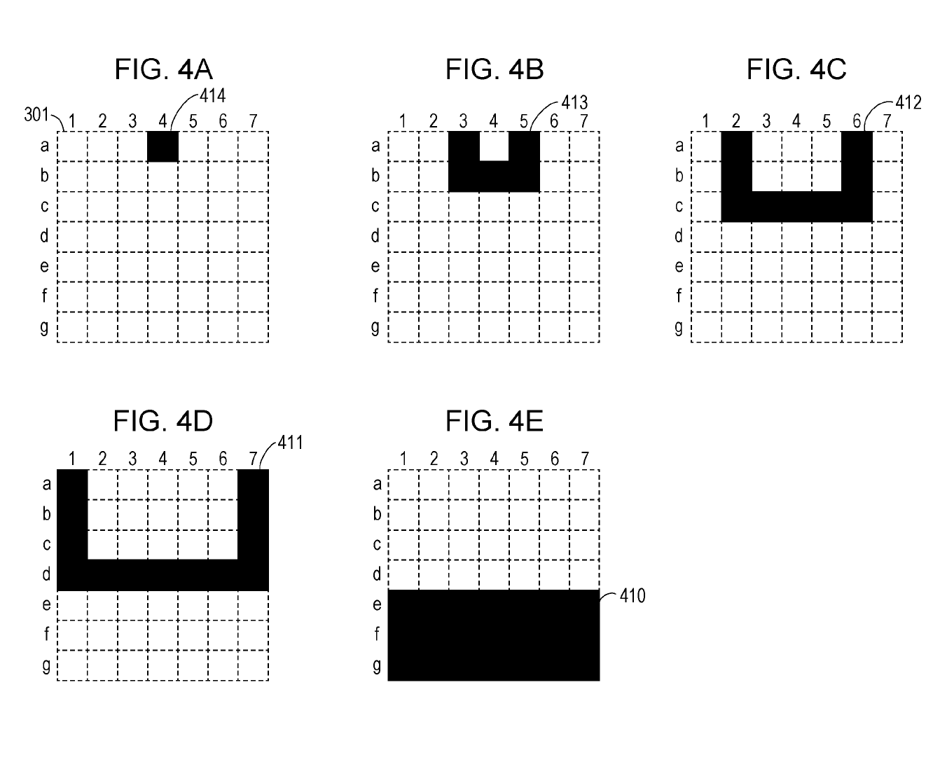

FIGS. 4A to 4E are explanatory diagrams for describing area groups obtained through grouping by some areas of the multiple sensor detection areas according to the present embodiment. Components identical to those illustrated in FIG. 3 are assigned with the identical reference numerals. According to the present embodiment, multiple area groups 414, 413, 412, and 411 are set in a concentric manner while an area a4 closest to the image processing apparatus 100 is set at a center. That is, according to the present embodiment, the multiple sensor detection areas are subjected to grouping into plural groups in accordance with a distance from the image processing apparatus 100. Hereinafter, the respective area groups will be described by using FIG. 4A, FIG. 4B, FIG. 4C, FIG. 4D, and FIG. 4E.

FIG. 4A illustrates an area group closest to the image processing apparatus 100.

In FIG. 4A, reference numeral 301 denotes an entire detection area illustrated in FIG. 3. An area group 414 includes the blacked area a4. Hereinafter, this area group will be described as Grp[4].

FIG. 4B illustrates an area group that is the second closest to the image processing apparatus 100.

In FIG. 4B, an area group 413 includes the blacked areas a3, b3, b4, b5, and a5. Hereinafter, this area group will be described as Grp[3].

FIG. 4C illustrates an area group that is the third closest to the image processing apparatus 100.

In FIG. 4C, an area group 412 includes the blacked areas a2, b2, c2, c3, c4, c5, c6, b6, and a6. Hereinafter, this area group will be described as Grp[2].

FIG. 4D illustrates an area group that is the fourth closest to the image processing apparatus 100.

In FIG. 4D, an area group 411 includes the blacked areas a1, b1, c1, d1, d2, d3, d4, d5, d6, d7, c7, b7, and a7. Hereinafter, this area group will be described as Grp[1].

FIG. 4E illustrates an area group farthest from the image processing apparatus 100.

In FIG. 4E, an area group 410 includes the blacked areas e1 to e7, f1 to f7, and g1 to g7. Hereinafter, this area group will be described as Grp[0].

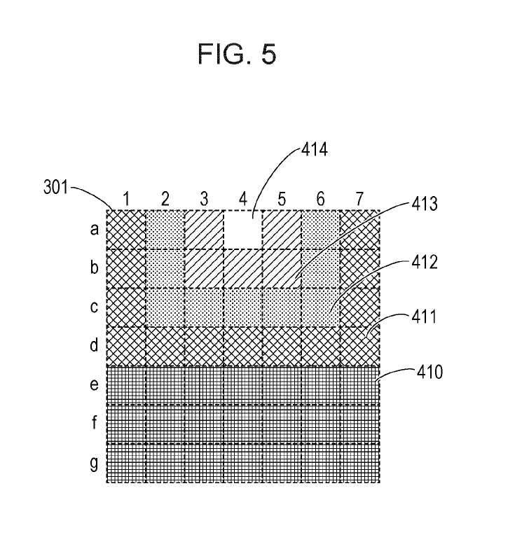

FIG. 5 illustrates the respective area groups illustrated in FIG. 4A, FIG. 4B, FIG. 4C, FIG. 4D, and FIG. 4E which are displayed using different grid patterns. Components identical to those illustrated in FIGS. 4A to 4E are assigned with the identical reference numerals.

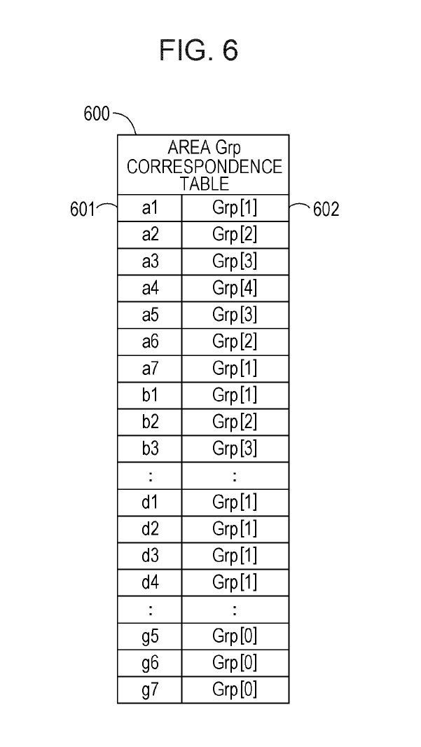

FIG. 6 illustrates an example of an area Grp correspondence table representing correspondences between the respective areas illustrated in FIGS. 4A to 4E and FIG. 5 and the respective area groups (Grp[0], Grp[1], Grp[2], Grp[3], and Grp[4]).

An area Grp correspondence table 600 represents in which area groups the respective areas are included. The area Grp correspondence table 600 is stored in the ROM 102 and is referred to by the CPU 101.

A detection location 601 represents a location detected by the sensor unit 104, and a reference numeral 602 represents in which area group each of the detection locations is included.

The correspondence between the detection location 601 in FIG. 6 and the area group refers to the one-to-one correspondence between the detection locations and the area groups illustrated in FIG. 5 including the detection locations.

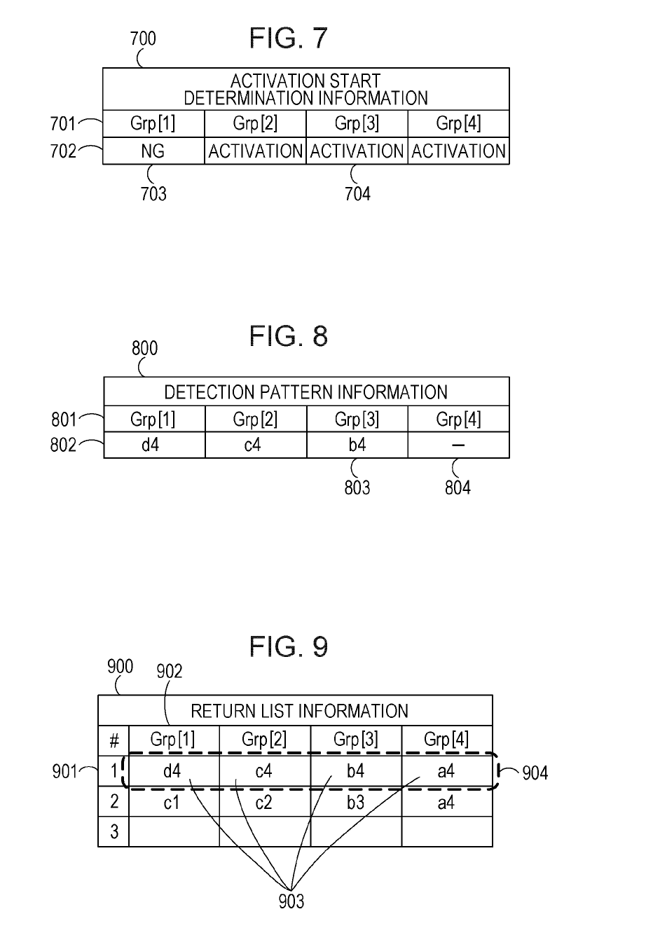

FIG. 7 illustrates an example of activation start determination information according to the present embodiment.

In FIG. 7, activation start determination information 700 is used to determine whether or not an activation is started (return to the normal state) for each of the respective area groups (Grp[1], Grp[2], Grp[3], Grp[4]) except for Grp[0] in a case where a person is detected in the relevant area group. The activation start determination information 700 is stored in the ROM 102 and referred to by the CPU 101.

Reference numeral 701 denotes each of the area group names, and a column 702 is used for storing “activation” or “NG” indicating whether the activation is stated or not for each of the area groups. That is, the column 702 is used for setting whether or not a return process to the normal state is started for each of the area groups.

“NG” denoted by reference numeral 703 indicates a setting of not starting the activation, and “activation” denoted by reference numeral 704 indicates a setting of starting the activation. Settings on which area group is set to “NG” and which area group is set to “activation” are made by the operation panel unit 105 in advance.

FIG. 8 illustrates an example of detection pattern information according to the present embodiment.

In FIG. 8, detection pattern information 800 is used for recording detection locations in the respective area groups (Grp[1], Grp[2], Grp[3], and Grp[4]) except for Grp[0] as a detection pattern in a case where the sensor unit 104 detects the presence of humans.

The detection pattern information 800 is stored in the RAM 103. When the sensor unit 104 detects the presence of a person, the CPU 101 writes a detection location name where the presence of the person is detected in each of the area groups with respect to the detection pattern information 800.

In the detection pattern information 800, respective area group names 801 are illustrated, and an area location 802 is written in each of the area groups.

A state 803 indicates that the area location is set, and a state 804 indicates that the area location is deleted.

The CPU 101 controls a power state of the image processing apparatus 100 on the basis of a comparison result between the detection pattern information 800 and detection patters recorded in return list information illustrated in FIG. 9 which will be later described (a detail of which will be described below).

FIG. 9 illustrates an example of return list information according to the present embodiment.

In FIG. 9, return list information 900 is configured to record multiple detection patterns each including an area location name for each of the area groups of Grp[1] to Grp[4] as one detection pattern (proximity pattern). The return list information 900 is stored in the ROM 102.

Detection pattern numbers 901 denote respective detection patterns in the return list information 900, and reference numeral 902 denotes an area group name column such as Grp[1].

Detection locations in the respective area groups in the detection pattern are denoted by reference numeral 903, and a detection pattern 904 corresponds to a combination of detection locations for each of the area groups.

A detection order may be identified by area group names. The detection order can be identified sequentially from the detection location information belonging to a group at the farthest distance from the image processing apparatus 100. That is, the detection order is Grp[1], Grp[2], Grp[3], and Grp[4] in the stated order.

In this manner, the return list information 900 can register a piece or multiple pieces of detection pattern information that can identify multiple pieces of detection location information and the detection order thereof.

The CPU 101 controls the power state of the image processing apparatus 100 on the basis of a comparison result between the detection pattern information 800 (FIG. 8) sequentially detected by the sensor unit 104 and stored and the detection pattern recorded in the return list information 900 (details of which will be described below).

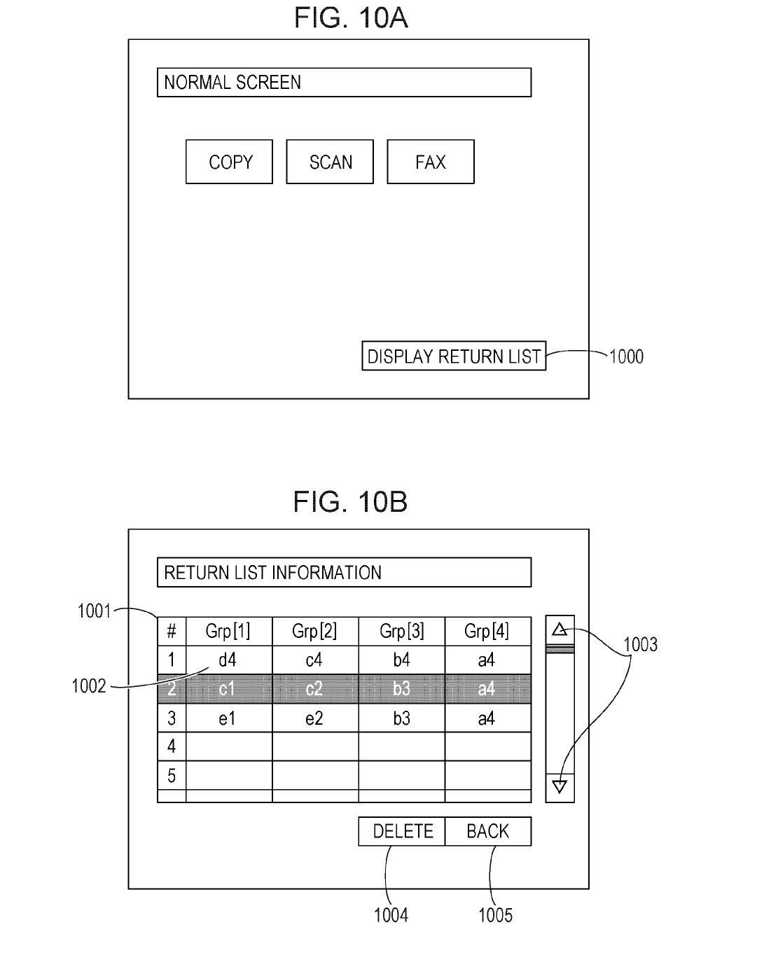

FIGS. 10A and 10B illustrate examples of a display screen of the operation panel unit 105.

FIG. 10A illustrates a normal screen of the operation panel unit 105.

In FIG. 10A, a return list display button 1000 is used to invoke a return-list-information selection deletion screen for deleting a detection pattern in the return list information 900.

FIG. 10B illustrates the return-list-information selection deletion screen when a detection pattern in the return list information 900 is selected and deleted.

In FIG. 10B, a return list display 1001 corresponds to a display of the return list information 900 in FIG. 9, and a selection pattern display 1002 displays a selected pattern among the return list display 1001.

A selection pattern switch button 1003 is used for moving the selection detection pattern to a next pattern. A deletion button 1004 is used for deleting the selection pattern display 1002 from the return list information 900. A back button 1005 is used for returning the screen from the return-list-information selection deletion screen to the normal screen illustrated in FIG. 10A.

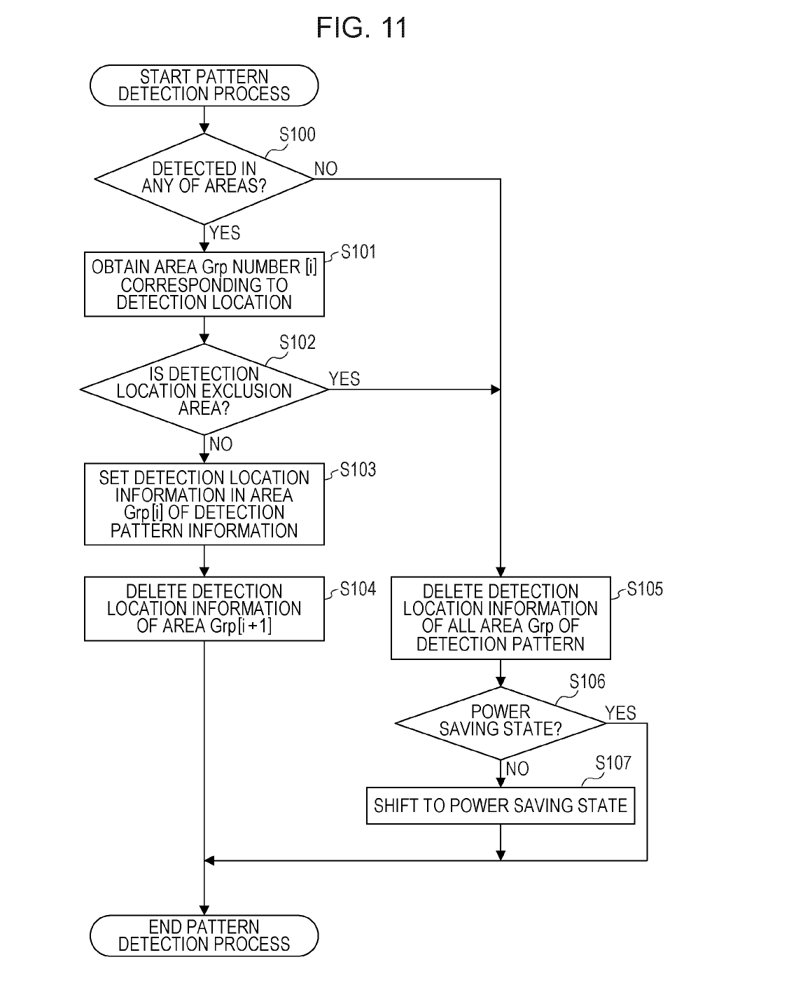

Next, with reference to FIG. 11 to FIG. 14, processing of detecting proximity of a user of the image processing apparatus according to the present embodiment and processing of shifting between the power saving state and the normal state will be described.

### Pattern Detection Processing

First, a pattern detection process according to the present embodiment will be described by using a flowchart of FIG. 11.

FIG. 11 is a flowchart of an example of the pattern detection process according to the present embodiment. The process of this flowchart is realized by the CPU 101 executing the computer-readable program recorded in ROM 102. The CPU 101 starts the process of this flowchart each time when the detection state of the sensor unit 104 is changed.

First, the CPU 101 confirms whether or not the sensor unit 104 detects the presence of a person at any of the multiple detection locations a1 to g7 of the sensor detection area 301 illustrated in FIG. 3 (S100).

In S100, when it is determined that the presence of a person is not detected at any of the locations (No in S100), the CPU 101 shifts the process to S105.

On the other hand, in S100, when it is determined that the presence of a person is detected at any of the detection locations (Yes in S100), the CPU 101 shifts the process to S101.

In S101, the CPU 101 obtains the area group number [i] corresponding to the detection location where the presence of a person is detected from the area Grp correspondence table (FIG. 6).

Next, the CPU 101 confirms whether or not the area group Grp[i] corresponding to the detection location obtained in S101 is a pattern exclusion area. According to the present embodiment, Grp[0] is set as the pattern exclusion area. That is, it is determined that the area group Grp[i] is the pattern exclusion area in a case where the obtained area group Grp[i] is Grp[0], and on the other hand, it is determined that the area group Grp[i] is not the pattern exclusion area in a case where the area group Grp[i] obtained above is other than Grp[0].

When it is determined in S102 that the area group Grp[i] obtained in S101 is the pattern exclusion area (Yes in S102), the CPU 101 shifts the process to S105.

On the other hand, when it is determined in S102 that the area group Grp[i] obtained in S101 is not the pattern exclusion area (No in S102), the CPU 101 shifts the process to S103.

In S103, the CPU 101 writes the detection location confirmed in S100 at the area location 802 prepared for each of the area groups in the detection pattern information 800 as the detection location information.

Next, in S104, the CPU 101 deletes the detection location information in the column of the area group+1 (that is, Grp[i+1]) in the detection pattern information 800 and ends the process of this flowchart.

In the case of No in S100 or Yes in S102, the CPU 101 deletes the detection location information of all the area group numbers in the detection pattern information 800 in S105.

Next, in S106, the CPU 101 determines whether or not the image processing apparatus 100 is in the power saving state.

When it is determined that the image processing apparatus 100 is in the power saving state (Yes in S106), the CPU 101 directly ends the process of this flowchart.

On the other hand, when it is determined that the image processing apparatus 100 is not in the power saving state (No in S106), the CPU 101 shifts to the power saving state in S107 and ends the process of this flowchart.

According to this flowchart, the description has been given of the configuration in which when a person is not detected at any of the detection locations by the sensor unit 104 (No in S100), the power state is shifted to the power saving state (S107), but the following configuration may also be adopted. For example, the power state may be shifted to the power saving state if a state where the sensor unit 104 does not detect a person at any of the detection locations continues for a predetermined time.

Hereinafter, as a specific example, a case in which the sensor unit 104 detects that the user exists at the area location d4 in the sensor detection area illustrated in FIG. 3 will be described along with the flowchart of FIG. 11.

The CPU 101 that has confirmed the presence of the person detected at the detection location d4 by the sensor unit 104 in S100 finds out that the detection location d4 is in Grp[1] from the area Grp correspondence table of FIG. 6 in S101.

Next, the CPU 101 determines in S102 that Grp[1] is not the exclusion area Grp[0], and the CPU 101 writes (sets) the detection location d4 in the column of Grp[1] of the detection pattern information 800 as the detection location information in S103.

Next, in S104, the CPU 101 deletes the detection location information of Grp[1+1], that is, Grp[2]. At this time point, (Grp[1], Grp[2], Grp[3], Grp[4]) of the detection pattern information 800 is (d4, -, -, -).

Moreover, in a case where the sensor unit 104 detects that the user exists at the area location c4 in the sensor detection area illustrated in FIG. 3, the CPU 101 similarly writes (sets) the detection location c4 in the column of Grp[2] of the detection pattern information 800 as the detection location information.

Furthermore, in a case where the sensor unit 104 detects that the user exists at the area location b4 in the sensor detection area illustrated in FIG. 3, the CPU 101 similarly writes (sets) the detection location b4 in the column of Grp[3] of the detection pattern information 800 as the detection location information. At this time point, (Grp[1], Grp[2], Grp[3], Grp[4]) of the detection pattern information 800 is (d4, c4, b4, -).

### Pattern Comparison/Addition Process

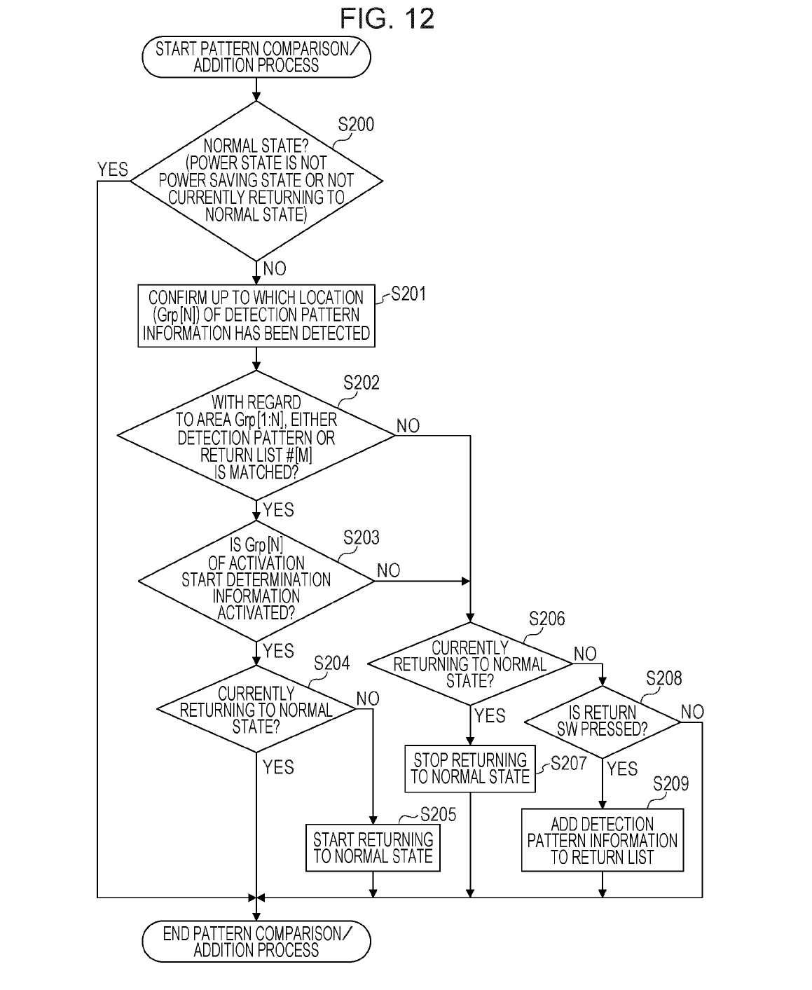

Hereinafter, a pattern comparison/addition process according to the present embodiment will be described by using a flowchart of FIG. 12.

FIG. 12 is a flowchart of an example of the pattern comparison/addition process according to the present embodiment. The process of this flowchart is realized by the CPU 101 executing the computer-readable program recorded in ROM 102.

In a case where the image processing apparatus 100 is not in the normal state, that is, a case where the image processing apparatus 100 is in the power saving state or currently performs the return process (No in S200), the CPU 101 executes the process in S201 and the subsequent process. It is noted that the subsequent process may be executed when the image processing apparatus 100 is in the power saving state or currently performs the return process and also each time when the new area location 802 is written in the detection pattern information 800 (FIG. 8).

In S201, the CPU 101 confirms up to which area group the detection location information has been written in the detection pattern information 800, that is, confirms which one of Grp[1] to Grp[4] the area Grp [N] is. Specifically, the CPU 101 sequentially confirms whether the detection location information has been written in the columns of Grp[1] to Grp[4] in the detection pattern information 800. The area group lastly confirmed that the detection area information has been written is the area Grp [N].

Next, in S202, the CPU 101 sets the respective pieces of detection location information from the area Grp [1] up to the area Grp [N] confirmed in S201 as one detection pattern and searches the return list information 900 for a matched detection pattern. Specifically, the combination of the respective pieces of detection location information from Grp[1] up to Grp[N] are compared with the combination of the detection pattern number 1 in the return list information 900. If those combinations are not matched with each other, the comparison is made with the combination of the detection pattern number 2 and then with each of the combinations of remaining detection pattern numbers to confirm whether or not the matching detection pattern exists.

When it is determined in S202 that the matching detection pattern exists in the return list information 900 (Yes in S202), the CPU 101 shifts the process to S203.

In S203, the CPU 101 checks the column of Grp[N] confirmed in S201 is “activation” or “NG” in the activation start determination information 700.

When it is determined in S203 that the column of Grp[N] is “activation” (Yes in S203), the CPU 101 shifts the process to S204.

In S204, the CPU 101 confirms whether or not the image processing apparatus 100 is currently returning to the normal state.

When it is determined in S204 that the image processing apparatus 100 is not currently returning to the normal state (No in S204), the CPU 101 advances the process to S205.

In S205, the CPU 101 starts the return process to the normal state and ends the process of this flowchart. That is, the CPU 101 starts the return process when the detection location information sequentially detected by the sensor unit 104 is matched with the detection-order leading part (part from Grp[1] to Grp[N]) of any of the detection pattern information registered in the return list information 900.

On the other hand, in S204, when it is determined that the image processing apparatus 100 is currently returning to the normal state (Yes in S204), the CPU 101 ends the process of this flowchart. That is, the CPU 101 continues the return process while the detection location information sequentially detected by the sensor unit 104 is matched with any of the detection pattern information registered in the return list information 900.

When it is determined in S202 that the matching pattern does not exist in the return list information 900 (No in S202) or when it is determined in S203 that the column of Grp[N] is not “activation” (that is, “NG”) (No in S203), the CPU 101 shifts the process to S206.

In S206, the CPU 101 confirms whether or not the image processing apparatus 100 is currently returning to the normal state.

When it is determined in S206 that the image processing apparatus 100 is currently returning to the normal state (Yes in S206), the CPU 101 shifts the process to S207.

In S207, the CPU 101 aborts the return process to the normal state and ends the process of this flowchart. That is, the CPU 101 aborts and discontinues the return process when the detection location information sequentially detected by the sensor unit 104 is not matched with any of the detection pattern information registered in the return list information 900.

On the other hand, in S206, when it is determined that the image processing apparatus 100 is not currently returning to the normal state (No in S206), the CPU 101 advances the process to S208.

In S208, the CPU 101 confirms whether or not the return switch 1500 of the operation panel unit 105 (FIG. 15B) is pressed.

When it is determined that the return switch 1500 is not pressed (No in S208), the CPU 101 ends the process of this flowchart.

That is, in a case where the latest detection location information detected by the sensor unit 104 belongs to the group set as NG (where the return process is not started), even if the sequentially detected detection location information up to the second latest detection location information (detection pattern of the area Grp [1:N]) is matched with any of the detection pattern information registered in the return list information 900, the return process is not started or not continued (aborted).

On the other hand, when it is determined that the return switch 1500 is pressed (Yes in S208), the CPU 101 advances the process to S209.

In S209, the CPU 101 adds the detection location information written in Grp[1] to Grp[4] in the detection pattern information 800 at that time to the return list information 900 as the detection pattern and ends the process of this flowchart.

Hereinafter, a process in a case, for example, where the user is in proximity to the detection locations d4, c4, and b4 while the image processing apparatus 100 is in the power saving state will be described as a specific example along with the flowchart of FIG. 12.

First, in a case where the image processing apparatus 100 is in the power saving state and the user exists in the detection location d4, (Grp[1], Grp[2], Grp [3], Grp[4]) of the detection pattern information 800 is (d4, -, -, -) through the pattern detection process illustrated in FIG. 11.

At this time, the CPU 101 determines in S200 that the image processing apparatus 100 is not in the normal state and confirms in S201 that Grp[N] is Grp[1] from the detection pattern information 800.

Next, in S202, the CPU 101 determines that the detection location d4 in the column of Grp[1] in the detection pattern information 800 is matched with the detection location d4 in the column of Grp[1] of the pattern number 1 in the return list information 900.

Furthermore, in S203, the CPU 101 confirms that the column of Grp[1] in the activation start determination information 700 is not “activation” (that is, “NG”). The CPU 101 confirms in S206 that the image processing apparatus 100 is not currently returning to the normal state and confirms in S208 that the return switch is not pressed.

After that, when the user moves to the detection location c4, (Grp[1], Grp[2], Grp [3], Grp[4]) of the detection pattern information 800 is (d4, c4, -, -) through the pattern detection process of FIG. 11.

At this time, the CPU 101 determines that Grp[N] is Grp[2] from the detection pattern information 800 in S201. Next, in S202, the CPU 101 determines that the combination of the detection locations d4 and c4 in the columns of Grp[1] and Grp[2] in the detection pattern information 800 is matched with the pattern number 1 in the return list information 900.

In S203, the CPU 101 further confirms that the column of Grp[2] in the activation start determination information 700 is “activation” and shifts the process to S204. Subsequently, the CPU 101 confirms in S204 that the image processing apparatus 100 is not currently returning to the normal state and starts the return process in S205.

After that, when the user moves to the detection location b4, (Grp[1], Grp[2], Grp [3], Grp[4]) of the detection pattern information 800 is (d4, c4, b4, -) through the pattern detection process of FIG. 11.

At this time, the CPU 101 determines in S201 that Grp[N] is Grp[3] from the detection pattern information 800. Next, in S202, the CPU 101 determines that the combination of the detection locations d4, c4, and b4 in the columns of Grp[1], Grp[2], and Grp[3] in the detection pattern information 800 is matched with the pattern number 1 in the return list information 900.

The CPU 101 further confirms in S203 that the column of Grp[2] in the activation start determination information 700 is “activation”, and the image processing apparatus 100 is currently returning to the normal state in S204, so that the process flow is ended. Hereinafter, while the detection pattern information 800 is matched with the pattern of the return list, the return process is continued. However, at a time point when the detection pattern information 800 is no longer matched with the pattern of the return list, the CPU 101 determines in S206 that the image processing apparatus 100 is currently returning to the normal state and aborts the return process in S207.

### Pattern Deletion Process

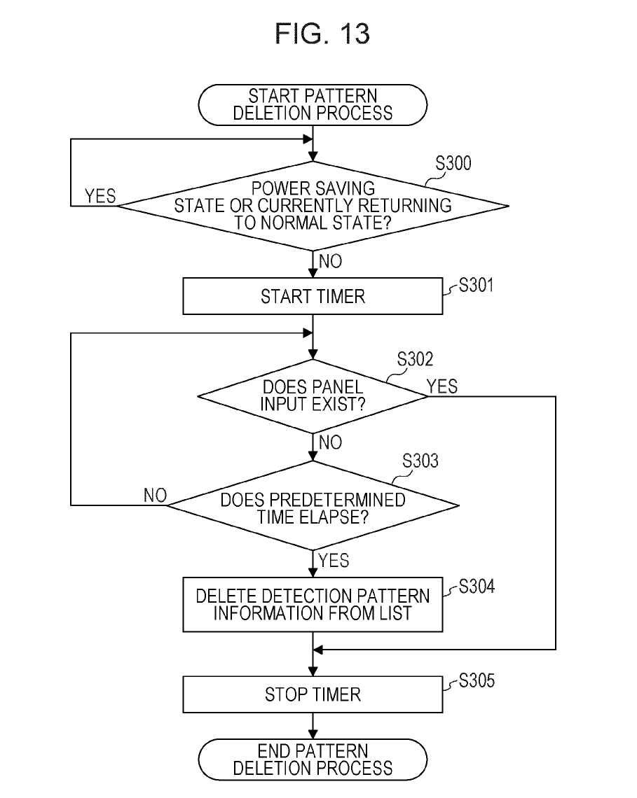

Hereinafter, a pattern deletion process according to the present embodiment will be described by using a flowchart of FIG. 13.

FIG. 13 is a flowchart of an example of the pattern deletion process according to the present embodiment. The process of this flowchart is realized by the CPU 101 executing the computer-readable program recorded in ROM 102.

In a case where the image processing apparatus 100 is not in the power saving state or is not currently returning to the normal state (No in S300), that is, immediately after the return from the power saving state to the normal state, the CPU 101 executes the process in S301 and the subsequent process.

In S301, the CPU 101 starts a timer to count a time and shifts the process to S302.

In S302, the CPU 101 confirms whether or not an input is made on the operation panel unit 105.

When it is determined in S302 that the input is made on the operation panel unit 105 (Yes in S302), the CPU 101 shifts the process to S305.

On the other hand, in S302, when it is determined that the input is not made on the operation panel unit 105 (No in S302), the CPU 101 shifts the process to S303.

In S303, the CPU 101 confirms whether or not a value of the timer that has started in S301 exceeds a predetermined time set on the operation panel unit 105.

When it is determined in S303 that the value of the timer does not exceed the predetermined time (No in S303), the CPU 101 returns the process to S302.

On the other hand, in S303, when it is determined that the value of the timer that has started in S301 exceeds the predetermined time (Yes in S303), that is, when an input is not made on the operation panel unit 105 while the timer that has started immediately after the return from the power saving state to the normal state counts the predetermined time, the CPU 101 advances the process to S304.

In S304, the CPU 101 deletes the combination of the detection location information of the area groups Grp[1], Grp[2], Grp[3], and Grp[4] recoded in the detection pattern information 800 at that time from the return list information 900 and shifts the process to S305.

In S305, the CPU 101 stops the timer and ends the pattern deletion process.

### Operation Panel Pattern Deletion Process

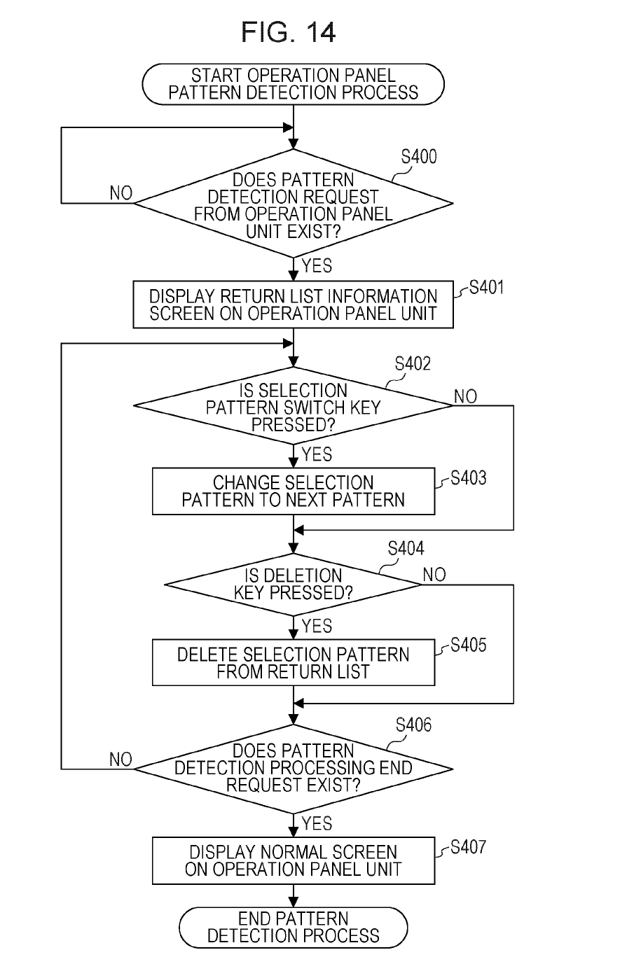

Hereinafter, the operation panel pattern deletion process according to the present embodiment will be described by using a flowchart of FIG. 14.

FIG. 14 is a flowchart of an example of the operation panel pattern deletion process according to the present embodiment. The process of this flowchart is realized by the CPU 101 executing the computer-readable program recorded in ROM 102.

In a case where the operation panel unit 105 issues a pattern deletion request, specifically, a case where the return list display button 1000 on the normal screen (FIG. 10A) displayed on the operation panel unit 105 is pressed, the CPU 101 executes the process in S401 and the subsequent process.

In S401, the CPU 101 displays the return list information screen (FIG. 10B) on the operation panel unit 105 and advances the process to S402.

In S402, the CPU 101 confirms whether or not the selection pattern switch button 1003 for moving the selection pattern display 1002 in FIG. 10B to a next detection pattern is pressed.

When it is determined in S402 that the selection pattern switch button 1003 is not pressed (No in S402), the CPU 101 advances the process to S404. On the other hand, when it is determined in S402 that the selection pattern switch button 1003 is pressed (Yes in S402), the CPU 101 advances the process to S403.

In S403, the CPU 101 moves the selection pattern display 1002 to the next detection pattern and shifts the process to S404.

In S404, the CPU 101 confirms whether or not the deletion button 1004 is pressed. Subsequently, in S404, when it is determined that the deletion button 1004 is not pressed (No in S404), the CPU 101 shifts the process to S406.

On the other hand, when it is determined in S404 that the deletion button 1004 is pressed (Yes in S404), the CPU 101 shifts the process to S405.

In S405, the CPU 101 deletes the detection pattern selected on the selection pattern display 1002 from the return list information 900 and shifts the process to S406.

In S406, the CPU 101 confirms whether or not a pattern deletion process end request exists. Specifically, it is determined that the pattern deletion process end request exists when the back button 1005 in FIG. 10B is pressed.

When it is determined in S406 that the pattern deletion process end request does not exist (No in S406), the CPU 101 returns the process to S402.

On the other hand, when it is determined in S406 that the pattern deletion process end request exists (Yes in S406), the CPU 101 advances the process to S407.

In S407, the CPU 101 displays the normal screen that is illustrated in FIG. 10A on the operation panel unit 105 and ends the present operation panel pattern deletion process.

Normally, in a case where the pyroelectric array sensor or the like that can detect humans for each of multiple detection areas such as the sensor unit 104 is used to determine proximity of the apparatus operator in detection patterns for the multiple areas, since a proximity route of the operator is changed depending on an installment situation (setting environment) of the image processing apparatus and the detection pattern varies, it is thought to be difficult to set appropriate detection patterns. In addition, if the image processing apparatus does not start the return process before the operator reaches a very close location to the image processing apparatus, the return process is not completed at a time point when the operator reaches the image processing apparatus. The operator may wait for the operation of the image processing apparatus until the completion of an activation process, and the usability of the operator may be degraded.

However, with the image processing apparatus 100 according to the present embodiment, it is possible to automatically register an appropriate proximity route in accordance with the installment situation (setting environment) as the detection pattern through the process of FIG. 11 to FIG. 13 described above, and it is also possible to automatically delete the detection pattern that is not regarded to be used afterwards in accordance with the change or the like of the installment situation (setting environment). Moreover, it is possible to manually delete the detection pattern that is not regarded to be used afterwards from the operation unit through the process illustrated in FIG. 14. A registration button for the return list function may be provided on the screen of FIG. 10B and a function with which the user can manually register the detection pattern in the return list may further be provided.

In addition, the image processing apparatus 100 according to the present embodiment starts the return process when the detection pattern detected by the sensor unit 104 is matched with a detection pattern registered in the return list up to a certain point, continues the return process while the detection patterns are matched with each other, and aborts the return process when the detection patterns are not matched with each other. Therefore, it is highly likely that the returning to the normal state is completed when the operator reaches the image processing apparatus, and it is possible to decrease the probability to a substantially low level that the operator stands by. As described above, with the image processing apparatus according to the embodiment of the present invention, the above-described problems (for example, the problem that the detection pattern registration is difficult and the problem that the usability of the operator is degraded) are also already solved, and it is possible to realize both the power saving feature and the usability at a high level.

Moreover, with the image processing apparatus 100 according to the present embodiment, the configuration in which the image processing apparatus is returned from the power saving state to the normal state by the proximity pattern detection using the pyroelectric sensor array has been described. However, the pyroelectric sensor array may also be combined with an infrared reflection type sensor as the configuration for detecting the proximity of the object such as humans to return the image processing apparatus from the power saving state to the normal state. For example, a configuration may also be adopted in which a power supply of the infrared reflection type sensor is turned on by the proximity pattern detection using the pyroelectric sensor array, and the image processing apparatus is returned to the normal state by the detection of the infrared reflection type sensor.

As described above, according to the embodiment of the present invention, when it is detected that the image processing apparatus 100 has returned to the normal state from the power saving state by the press of the return switch, the detection location of the sensor that can detect the presence of the humans (objects) for multiple areas and the detection order are registered as the detection pattern (proximity pattern) of the operator, and after that, the image processing apparatus 100 is returned from the power saving state to the normal state when such proximity pattern is detected. According to this, the proximity of the operator in accordance with the installment situation of the image processing apparatus can be detected at a high level. Furthermore, since the return process is started when the detection pattern is matched with the registered detection pattern up to a certain point, the return process to the normal state is completed before the operator reaches the image processing apparatus, and the usability for the user can be improved.

In this manner, with the image processing apparatus according to the embodiment of the present invention, it is possible to realize both the suppression of the wasteful power consumption based on the unwanted return process caused by the accidental detection of a person as the operator and the prompt return from the sleep state at a high level.

The description has been given of the configuration in which the CPU 101, the ROM 102, and the RAM 103 are included in the continuous power supply group 117 illustrated in FIG. 1, but these components may be provided in the non-continuous power supply group 118, and a sub processor (sub control unit) that saves more power than the CPU 101, the ROM 102, and the RAM 103 may be provided in the continuous power supply group 117. In this case, the process during the power saving state among the above-described processes is conducted by the above-described sub processor. According to this, the power consumption in the power saving state can be reduced more, and the further power saving can be realized.

The configurations of the above-described various data and the contents thereof are not limited to the above, and various configurations and contents may be employed in accordance with the usage and the purpose.

The embodiment has been described above, but the present invention can adopt a mode, for example, as a system, an apparatus, a method, a program, a storage medium, or the like. Specifically, the embodiment may be applied to a system composed of multiple devices or may also be applied to an apparatus composed of a single device.

In addition, combined configurations where the above-described respective embodiments are combined to each other are all included in the present invention.

### Other Embodiments

The present invention is also realized by executing the following process. That is, software (program) that realizes the function of the above-described embodiment is supplied to a system or an apparatus via a network or various storage media, and a computer (or a CPU, an MPU, or the like) of the system or the apparatus reads out the program and executes the process.

The present invention may also be applied to a system composed of multiple devices or an apparatus composed of a single device.

The present invention is not limited to the above-described embodiments. Various modifications based on the gist of the present invention (including organic combinations of the respective embodiments) can be made, and those are not excluded from the scope of the present invention. That is, combined configurations of the above-described respective embodiments and modification examples thereof are all included in the present invention.

### EFFECT OF THE INVENTION

According to the embodiment of the present invention, it is possible to realize both the suppression of the wasteful power consumption based on the unwanted return process caused by the accidental detection of a person as the operator and the prompt return from the sleep state at a high level.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-264255, filed Dec. 3, 2012 which is hereby incorporated by reference herein in its entirety.

What is claimed is:

1. An image processing apparatus in which a power state is switchable between a first power state and a second power state where a power consumption is lower than in the first power state, the image processing apparatus comprising:
a detection unit configured to detect a presence of an object for a single area or multiple areas individually and obtain a location of each of the areas where the object is detected as detection location information;
a registration unit configured to register a piece or multiple pieces of detection pattern information that can identify a piece or multiple pieces of detection location information and a detection order thereof; and
a control unit configured to perform control such that a return process for switching the power state from the second power state to the first power state is started when the detection location information sequentially detected by the detection unit is matched with a detection-order leading part of any of the detection pattern information registered in the registration unit, the return process is continued while the detection pattern information is matched, and the return process is not continued when the detection pattern information is not matched.

2. The image processing apparatus according to claim 1, further comprising:
an instruction unit configured to return the power state from the second power state to the first power state through a user operation,
wherein, in a case where the instruction unit is instructed, the control unit registers in the registration unit the detection location information sequentially detected by the detection unit until the instruction unit is instructed as the detection pattern information.

3. The image processing apparatus according to claim 1, further comprising:
an operation unit configured to operate the image processing apparatus,
wherein, in a case where an operation by the operation unit is not conducted until a predetermined time elapses since the power state is returned to the first power state by the return process, the control unit deletes the detection pattern information matched in the return process from the registration unit.

4. The image processing apparatus according to claim 1,
wherein the detection pattern information is composed of the detection location information for each group obtained through grouping of detection areas for the detection unit into multiple groups in accordance with a distance from the image processing apparatus and identifies that the detection location information belonging to a group at a distance farther from the image processing apparatus is detected first in sequence, and
wherein the control unit determines the matching for each group.

5. The image processing apparatus according to claim 4,
wherein the groups are obtained through grouping in a concentric manner with the detection unit being set at a center.

6. The image processing apparatus according to claim 4, further comprising:
a setting unit configured to set whether or not the return process is started for each group,
wherein the control unit does not start or continue the return process in a case where the latest detection location information detected by the detection unit belongs to a group where the setting unit sets that the return process is not started even when the sequentially detected detection location information up to the second latest detection location information is matched with any of the detection pattern information registered in the registration unit.

7. The image processing apparatus according to claim 1, further comprising:
a deletion unit configured to individually delete the detection pattern information registered in the registration unit through a user operation.

8. The image processing apparatus according to claim 1,
wherein the first power state corresponds to a state in which an image is formed, and the second power state corresponds to a state in which an image is not to be formed.

9. A control method for an image processing apparatus in which a power state is switchable between a first power state and a second power state where a power consumption is lower than in the first power state and which includes a detection unit configured to detect a presence of an object for a single area or multiple areas individually and specify a location of each of the areas where the object is detected as detection location information, the control method comprising:
causing a control unit to perform control such that a return process for switching the power state from the second power state to the first power state is started when the detection location information sequentially detected by the detection unit is matched with a detection-order leading part of any of detection pattern information registered in a registration unit configured to register a piece or multiple pieces of detection pattern information that can identify a piece or multiple pieces of detection location information and a detection order thereof, the return process is continued while the detection pattern information is matched, and the return process is not continued when the detection pattern information is not matched.

10. A program for causing a computer to execute the control method for the image processing apparatus according to claim 9.

11. An image forming apparatus comprising:
a detection unit including a plurality of detectors that can detect an object;
a return unit that is configured to return the image forming apparatus from a power saving state and is operated by a user; and
a registration unit configured to register detection states of the plurality of detectors before the return unit is operated in a case where the return unit is operated by the user; and
a control unit configured to return the image forming apparatus from the power saving state in a case where it can be determined that detection states of the plurality of detectors with respect to the object are matched with the detection states registered in the registration unit when the image forming apparatus is in the power saving state.

12. The image forming apparatus according to claim 11, further comprising:
a deletion unit configured to delete the detection states registered in the registration unit if the image forming apparatus is not used and is shifted to the power saving state in a case where the image forming apparatus is returned from the power saving state while it is determined that detection states of the plurality of detectors with respect to the object are matched with the detection states registered in the registration unit.

13. The image forming apparatus according to claim 11,
wherein the plurality of detectors includes detectors that belong to a first group and detectors that belong to a second group and set locations closer to the image forming apparatus than the detectors that belong to the first group as a detection range, and
wherein the control unit returns the image forming apparatus from the power saving state in a case where it can be determined that detection states of the detectors that belong to the second group with respect to the object are matched with the detection states registered in the registration unit.

14. The image forming apparatus according to claim 11,
wherein the control unit returns the image forming apparatus from the power saving state while it can be determined that the detection states of the plurality of detectors with respect to the object are matched with the detection states registered in the registration unit and aborts the returning of the image forming apparatus from the power saving state when the detection states of the plurality of detectors with respect to the object are not matched with the detection states registered in the registration unit.
